(19) United States
(12) Patent Application Publication
(10) Pub. No.: US 2021/0029061 A1
(43) Pub. Date: Jan. 28, 2021

(54) A CONTROL APPARATUS, IN-VEHICLE COMMUNICATION SYSTEM, MONITORING METHOD AND PROGRAM

(71) Applicant: NEC CORPORATION, Tokyo (JP)

(72) Inventor: Yasuhiro MIZUKOSHI, Tokyo (JP)

(73) Assignee: NEC CORPORATION, Tokyo (JP)

(21) Appl. No.: 16/980,720

(22) PCT Filed: Aug. 30, 2018
(86) PCT No.: PCT/JP2018/032179

§ 371 Date: Sep. 14, 2020

(30) Foreign Application Priority Data
Mar. 28, 2018 (JP) 2018-061360

(51) Int. Cl. H04L 12/939; G05B 23/02; B60R 16/023; G07C 5/08; H04L 12/937; H04L 12/931; H04L 12/40

(52) U.S. Cl. CPC H04L 49/557; G05B 23/0264; B60R 16/0231; G07C 5/0808; H04L 2012/40273; H04L 49/351; H04L 49/555; H04L 12/40195; H04L 12/40182; H04L 49/254

(57) ABSTRACT

A control apparatus controls communication in a vehicle by setting a control entry(ies) to a plurality of switches relaying, by referring to the control entry(ies), a packet(s) input to and output from an ECU(s) installed in the vehicle. The control apparatus sets a second control entry for detecting the packet(s) transmitted from the ECU(s), triggered by that a frequency of communication of the ECU(s) exceeds a predetermined threshold value, and determines any one of failure of the ECU(s) and a fault of a communication path(s) according to combination of the switch(es) and a port(s) in which interruption of the packet(s) transmitted from the ECU(s) is detected.

### FIELD

### [Description of the Related Application]

This application is a National Stage of International Application No. PCT/JP2018/032179 filed Aug. 30, 2018, claiming priority based on Japanese Patent Application No. 2018-061360 filed Mar. 28, 2018, the disclosure of which is incorporated herein in its entirely by reference.

### BACKGROUND

Patent Literature 1 discloses a vehicle-mounted gateway (called “GWECU”) which performs protocol conversion between an ECU corresponding to a CAN and an ECU corresponding to a communication protocol other than the CAN. Also, this Literature describes that a gateway monitors a voltage between the ECU corresponding to the CAN and the gateway or a communication cycle period from the ECU corresponding to the CAN in order to prevent that an illegal message is relayed from the ECU corresponding to CAN to the an ECU corresponding to another protocol. Here, “CAN” is an abbreviation of “Controller Area Network” and “ECU” is an abbreviation of “Electronic Control Unit”.

Patent Literature 2 discloses a configuration that connects two vehicle-mounted gateways by two communication paths via an Ethernet (hereinafter, “Ethernet” is a registered trademark) path and continues communication by using the one communication path when a fault of the other communication path occurs.

In addition, in recent years, a technology called SDN (Software Defined Network) that realizes virtualization of network, by using software is known. Non-Patent Literature 1 is a specification of OpenFlow Switch which is used in a case of constituting the SDN.

Patent Literature 3 discloses a vehicle-mounted gateway having a switching function equivalent to the OpenFlow controller and OpenFlow switch.

Patent Literature 4 discloses a configuration that a communication node in a centralized control type communication system represented by the OpenFlow can perform a switch of a path without waiting an instruction form a control apparatus.

Patent Literature 1: Japanese Patent kokai Publication No. 2016-111477A

Patent Literature 2: Japanese Patent kokai Publication No. 2017-5617A

Patent Literature 3: Japanese Patent kokai Publication No. 2017-184052A

Patent Literature 4: Japanese Patent kokai Publication No. 2015-12531A

Non-Patent Literature 1: OpenFlow Switch Specification Version 1.5.1 (Protocol version 0x06), ONF, [online], [search on March 16, Heisei 30 (2018)], Internet <URL: https://3vf60mmveq1g8vzn48q2o71a-wpengine.netdna-ss1.com/wp-content/uploads/2014/10/openflow-switch-v1.5.1. pdf>

### SUMMARY

Following analyses are given by the present invention. It is assumed that many ECUs will be installed on a next generation vehicle and they will cooperate with each other and play a critical role represented by automated driving. Therefore, it is required that not only an abnormality of each part of a vehicle but also a condition of a communication path is monitored and a high-speed restoration processing is performed if possible.

It is considered that a frame for inspection such as a CCM (Continuity Check Message) or the like is sent periodically to a range to be monitored periodically, as a scheme monitoring the condition of the communication path. Patent Literature 4 relates to a technology causing to transmit a condition monitoring packet to a communication node and is located as a kind of a scheme transmitting the frame for inspection. However, if this scheme will be used for an early detection of an abnormality, a frequency of transmission of a frame for inspection becomes to be high, thereby, a problem such as suppression of a communication band range or affecting power saving arises. In contrast, if the frequency of transmission of the frame for inspection is low, it is not possible to perform the early detection of the abnormality.

It is an object of the present invention to provide a control apparatus, in-vehicle communication system, monitoring method and program that can contribute to enrichment of a configuration being capable of detecting an abnormality of each part of a vehicle or a communication path without performing transmission of the above frame for inspection or the like.

According to a first aspect, there is provided a control apparatus including: a control part which controls communication in a vehicle by setting a control entry(ies) to a plurality of switches relaying, by referring to the control entry(ies), a packet(s) input to and output from an ECU(s) installed on the vehicle, wherein the control part sets a second control entry(ies) for detecting the packet(s) transmitted from the ECU(s), triggered by that a frequency of communication of the ECU(s) exceeds a predetermined threshold value and determines any one of failure of the ECU(s) and a fault of a communication path(s) according to combination of the switch(es) and a port(s) in which interruption of the packet(s) transmitted from the ECU(s) is detected.

According to a second aspect, there is provided an in-vehicle communication system including: a plurality of switches which relays a packet(s) input to and output from an ECU(s) installed on a vehicle by referring to a control entry(ies), and the above control apparatus.

According to a third aspect, there is provided a monitoring method in a control apparatus including a control part that controls communication in a vehicle by setting a control entry(ies) to a plurality of switches relaying, by referring to the control entry(ies), a packet(s) input to and output from an ECU(s) installed on the vehicle, the method comprising: by the control apparatus, setting a second control entry for detecting the packet(s) transmitted from the ECU(s), triggered by that a frequency of communication of the ECU(s) exceeds a predetermined threshold value, and determining any one of failure of the ECU(s) and a fault of a communication path(s) according to combination of the switch(es) and a port(s) in which interruption of the packet(s) transmitted from the ECU(s) is detected. The method is coupled with a specified machine which is a control apparatus realizing communication in a vehicle by setting a control entry(ies) to a switch(es).

According to a fourth aspect, there is provided a computer program for realizing a function(s) of the above control apparatus. In addition, this program(s) can be recorded in a computer readable (non-transitory) recording medium. Namely, the present invention can also be embodied as a computer program product.

According to the present invention, it is possible to detect an abnormality of each part of a vehicle or a communication path(s) without performing transmission of the above frame for inspection or the like.

### BRIEF DESCRIPTION OF THE DRAWINGS

FIG. 1 is a diagram illustrating a configuration of an exemplary embodiment of the present invention.

FIG. 2 is a diagram for explaining an operation of an exemplary embodiment of the present invention.

FIG. 3 is a diagram illustrating a configuration of an in-vehicle communication system in a first exemplary embodiment of the present invention.

FIG. 4 is a function block diagram illustrating a configuration of an OFC of an in-vehicle communication system in the first exemplary embodiment of the present invention.

FIG. 5 is a sequence diagram illustrating an operation of an in-vehicle communication system in the first exemplary embodiment of the present invention.

FIG. 6 is a sequence diagram illustrating an operation of an in-vehicle communication system in the first exemplary embodiment of the present invention.

FIG. 7 is a sequence diagram illustrating an operation of an in-vehicle communication system in the first exemplary embodiment of the present invention.

FIG. 8 is a sequence diagram illustrating an operation of an in-vehicle communication system in the first exemplary embodiment of the present invention.

FIG. 9 is a sequence diagram illustrating an operation of an in-vehicle communication system in a second exemplary embodiment of the present invention.

FIG. 10 is a sequence diagram illustrating an operation of an in-vehicle communication system in the second exemplary embodiment of the present invention.

FIG. 11 is a sequence diagram illustrating an operation of an in-vehicle communication system in a third exemplary embodiment of the present invention.

FIG. 12 is a sequence diagram illustrating an operation of an in-vehicle communication system in the third exemplary embodiment of the present invention.

FIG. 13 is a sequence diagram illustrating an operation of an in-vehicle communication system in the third exemplary embodiment of the present invention.

FIG. 14 is a sequence diagram illustrating an operation of an in-vehicle communication system in the third exemplary embodiment of the present invention.

FIG. 15 is a sequence diagram illustrating an operation of an in-vehicle communication system in a fourth exemplary embodiment of the present invention.

FIG. 16 is a sequence diagram illustrating an operation of an in-vehicle communication system in the fourth exemplary embodiment of the present invention.

FIG. 17 is another sequence diagram illustrating an operation of an in-vehicle communication system in the second exemplary embodiment of the present invention.

FIG. 18 is another sequence diagram illustrating an operation of an in-vehicle communication system in the fourth exemplary embodiment of the present invention.

FIG. 19 is a diagram for explaining a variation of an exemplary embodiment of an in-vehicle communication system of the present invention.

FIG. 20 is a diagram illustrating a configuration of a computer configurating a control apparatus of the present invention.

### PREFERRED MODES

Firstly, an overview of an exemplary embodiment of the present invention will be explained by using figures. In addition, drawing reference signs added to the overview are signs added to each element as an example for convenience to help the understanding, and it is not intended that the present invention is limited to illustrated exemplary embodiments. Further, a connection path(s) between blocks in figures or the like referring to the following description includes both bidirectional and unidirectional. One-way arrow indicates schematically flow of primary signal (data), and does not excluded bidirectionality. In addition, in a connection point of input and output of each block in figures, a port(s) or interface exist, but explicit description is omitted in figures.

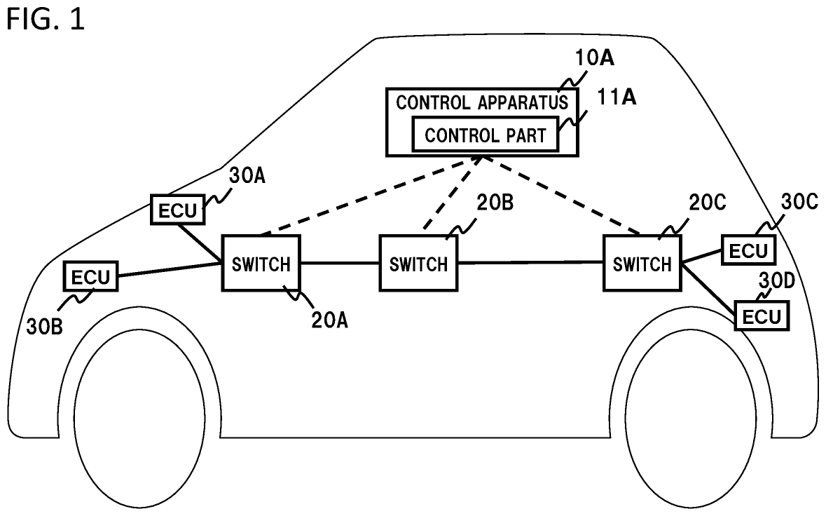

In an exemplary embodiment, as illustrated in FIG. 1, the present invention is realized by a control apparatus 10A which controls a plurality of switches 20A to 20C (hereinafter, referred to as a “switch 20” as far as it is not necessary to distinguish the switches 20A to 20C especially) installed on a vehicle by referring to a control entry(ies).

More concretely, the plurality of switches 20 relays a packet(s) input to and output from ECUs 30A to 30D (hereinafter, referred to as an “ECU 30” as far as it is not necessary to distinguish the ECUs 30A to 30D especially) installed on the vehicle by referring to the control entry(ies). In addition, though it is explained as that a number of ECU 30 is four in an example of FIG. 1, the number of ECU(s) is not limited to this number.

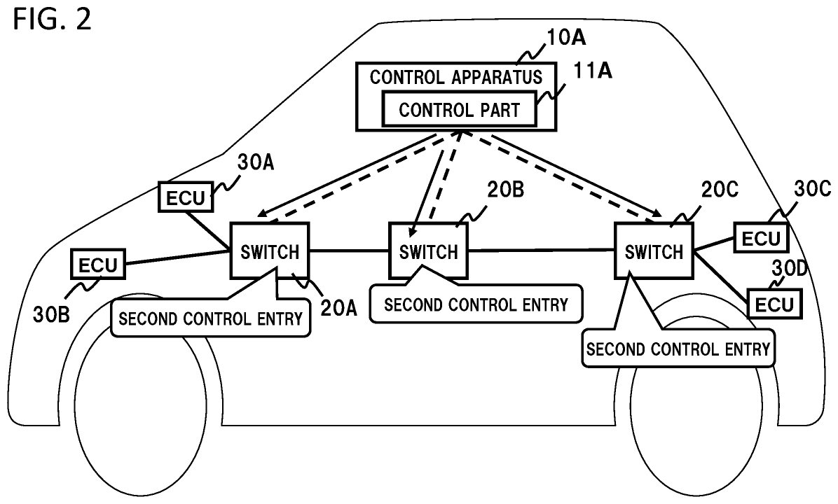

And, as illustrated in FIG. 2, the control apparatus 10A includes a control part 11A. This control part 11A controls communication in the vehicle by setting the control entry(ies) to the switch 20. In addition, it is not necessary that the ECU 30 communicates with other all ECU(s) and it is enough to communicate with other ECU(s) relating to an own function or with a sensor.

Further, for example, as illustrated in FIG. 2, triggered by that a frequency of communication of the ECU 30 exceeds a predetermined threshold value, this control part 11A sets, to the switch 20, a second control entry for detecting the packet(s) transmitted from the ECU 30. And, the control part 11A determines any one of failure of the ECU 30 and a fault of a communication path(s) according to combination of a switch(es) and port(s) in which interruption of the packet(s) transmitted from the ECU 30 is detected.

Here, a value which can detect that the ECU 30 is activated and regular packet transmission operation is started is set, as the “predetermined threshold value” which is compared with the frequency of communication of the ECU 30 when the control part 11A determines whether or not setting the second control entry. For example, if the ECU 30A periodically reports, to the ECU 30D, a value which is managed by itself, a lower value than a frequency of report is set as the “predetermined threshold value”. In this way, the reason for not setting the second control entry from the beginning resides in that communication disconnection in a non-steady state after operation start of an ECU(s) by activation or the like of a vehicle system is not caused to determine as failure.

In addition, as a mechanism of detecting the communication disconnection of the ECU(s) by the second control entry, it is considered that there is a mechanism of setting a timeout value to the second control entry and detecting disappearance of the second control entry by a timeout. Or, it may be determined to be the communication interruption (disconnection) in a case where flow statistical information or the like of the second control entry is inquired from the control apparatus 10A to the switch 20 and change in this value is from “0” to less than a predetermined value.

And, the control part 11A can determine any one of failure of the ECU 30 and a fault of a communication path(s) according to a position where the communication is interrupted (disconnected). For example, when the second control entry in which the communication interruption is detected monitors the packet(s) output from the ECU 30A in the switch 20A of FIG. 2, the ECU 30A or a communication path(s) between the ECU 30A and switch 20A becomes a suspected failure position.

Similarly, when the second control entry in which the communication interruption is detected monitors the packet(s) output from the ECU 30A in the switch 20C of FIG. 2, a communication path(s) between the switches 20B and 20C becomes a suspected failure position.

As mentioned above, according to the present exemplary embodiment, it is possible to detect an abnormality of each part of a vehicle or a communication path(s) without performing transmission or the like of the above frame for inspection. The reason resides in that a configuration being capable to narrow a target of a suspected failure position by using a packet(s) transmitted from another ECU(s) or the like regularly in a steady state of the ECU 30 is adopted.

Further, though it is explained mainly about a function that the control apparatus 10A narrows a target of the suspected failure position in the above explanation, it is possible to cause the control apparatus 10 to perform detailed inspection or a recovery measure according to the suspected failure position, if necessary. For example, as a detailed inspection, it is possible to cause the control apparatus 10A to transmit an instruction destined to an ECU(s) or to transmit a test packet(s) in order to further narrow a target of suspected failure position. For example, as the recovery measure, it is possible to cause the control apparatus 10A to reset a communication path(s) by selecting or activating an ECU(s) of backup or switch over to a path(s) bypassing a problematic link(s).

### FIST EXEMPLARY EMBODIMENT

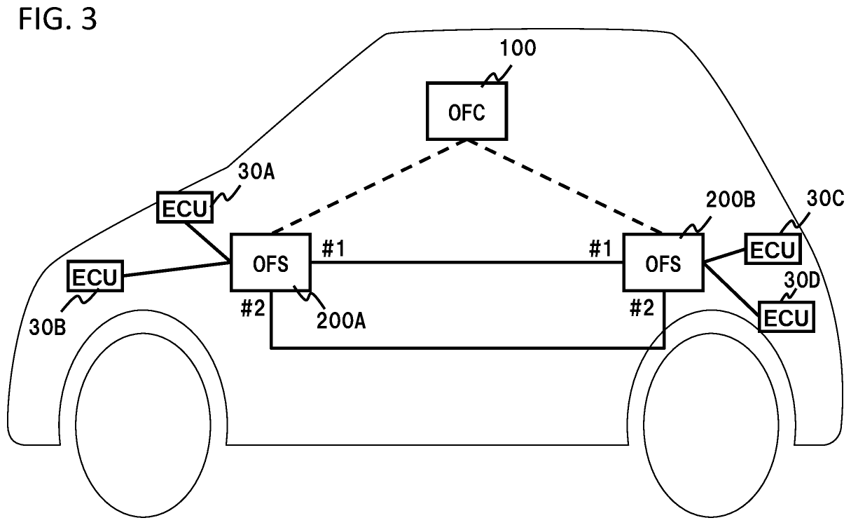

Successively, it will be explained about a first exemplary embodiment of the present invention including a diagnosis function and a recovery function of a communication path(s) (a link(s)) between OFSs by referring to figures in detail. FIG. 3 is a diagram illustrating a configuration of an in-vehicle communication system in the first exemplary embodiment of the present invention. Referring to FIG. 3, a configuration in which an OpenFlow controller (OFC) 100 and a plurality of OpenFlow switches (OFSs) 200A to 200C are arranged in a vehicle is illustrated. Further, hereinafter, it is referred to as an “OFS 200” as far as it is not necessary to distinguish the OpenFlow switches 200A and 200B especially.

The OFC 100 is a device equivalent to an OpenFlow controller described in Non-Patent Literature 1, and corresponds to the above control apparatus 10A.

The OFS 200 selects a communication path(s) and realizes communication between ECUs 30 or communication between the ECU 30 and a sensor in accordance with a flow entry(ies) set from the OFC 100. In an example of FIG. 3, a first link connected between ports #1, #1 and a second link connected between ports #2, #2 are provided. Further, in the example of FIG. 3, though two switches are illustrated, three or more switches may be arranged.

The OFC 100 and OFS 200 are connected via a control channel illustrated by broken lines of FIG. 3.

The ECU 30 is a device which controls each part of the vehicle such as an engine, electric motor, battery, transmission gear, or the like, for example. In addition, it is assumed that the ECU 30 corresponds to any of a CAN and Ethernet in the present exemplary embodiment.

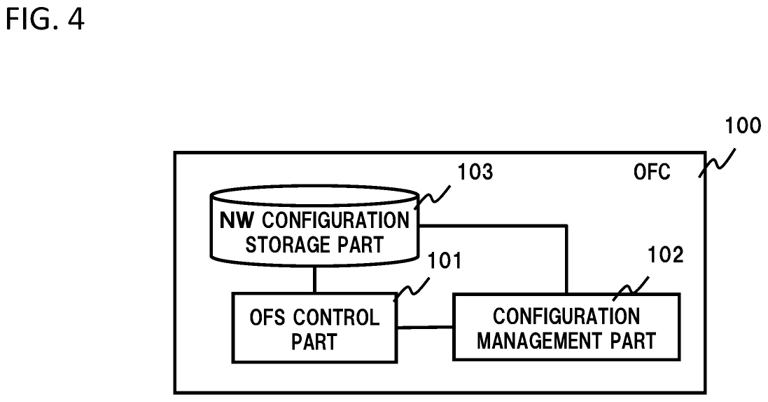

Continuingly, it will be explained about a configuration of the OFC 100 realizing the communication between the above ECUs 30 by referring to figures in detail. FIG. 4 is a diagram illustrating a configuration of the OFC 100 in the first exemplary embodiment of the present invention. The OFC 100 in FIG. 4 includes an OFS control part 101, configuration management part 102, and network configuration storage part (NW configuration storage part) 103.

The NW configuration storage part 103 stores information of connection relation of the plurality of OFSs 200 and information of an ECU(s), a sensor, or the like connected to each of OFSs.

The OFS control part 101 generates a flow entry(ies) realizing the communication between the ECUs 30 by referring to the NW configuration storage part 103 and sets it to the OFS 200. Further, the OFC 100 need not to generate the flow entry(ies) on each occasion and some of the flow entries may be set at the time the vehicle is shipped for example. Since a basic operation of these the OFC 100 and OFS 200 is described in Non-Patent Literature 1, explanation is omitted.

The configuration management part 102 refers to the NW configuration storage part 103 and instructs the OFS control part 101 to set, to the OFS 200 positioned at a downstream side of a communication path(s) (link(s)) to be diagnosed, a second control entry for detecting a packet(s) transmitted from the ECU 30. In the following explanation, since a link(s) between the OFS 200A and OFS 200B is a target for diagnosis, a set destination of the second flow entry is any one of the OFSs 200A and 200B. In the present exemplary embodiment, since the ECU 30A transmits a packet(s) to the ECU 30D periodically, an OFS positioned at an upstream side becomes the OFS 200B. In addition, a timing that the configuration management part 102 instructs setting of the second flow entry becomes a timing that a frequency of transmission (a frequency of communication) of a packet(s) destined to the ECU 30D in the ECU 30A exceeds a predetermined threshold value.

In addition, in the present exemplary embodiment, it is assumed that a flow entry(ies) to which an idle timeout value is set is used as the second flow entry. Here, an “idle timeout” means a process equivalent to aging in a layer 2 switch(es) that causes the flow entry(ies) to invalidate (timeout) when a packet(s) adapted to a match condition is not received for a period of time set as an idle timeout value or more. By using this flow entry(ies), it is possible to grasp that a corresponding packet(s) is not received in the switch 200B in spite of transferring a packet(s) by the switch 200A, that is, an occurrence of communication interruption. Further, this idle timeout value is determined dependent on a transmission period or data type of data which the ECU(s) of the transmission source transmits. For example, as the idle timeout value, a value such as n times value (however, n is an arbitrary value exceeding “1”. For example, “3” times) or the like of the frequency of transmission (frequency of communication) of the packet(s) destined to ECU 30D in the ECU 30A can be adopted.

Actually, when a state that the switch 200B does not receive a corresponding packet(s) from the switch 200A continues, the second flow entry becomes a timeout and is deleted, and a report is performed from the OFS 200B to the OFC 100. Thereby, the configuration management part 102 determines that communication interruption between the switch 200A and switch 200B has occurred and requests, to the OFS control part 101, calculation of a bypass route and setting of a flow entry(ies) realizing packet transfer by the bypass route.

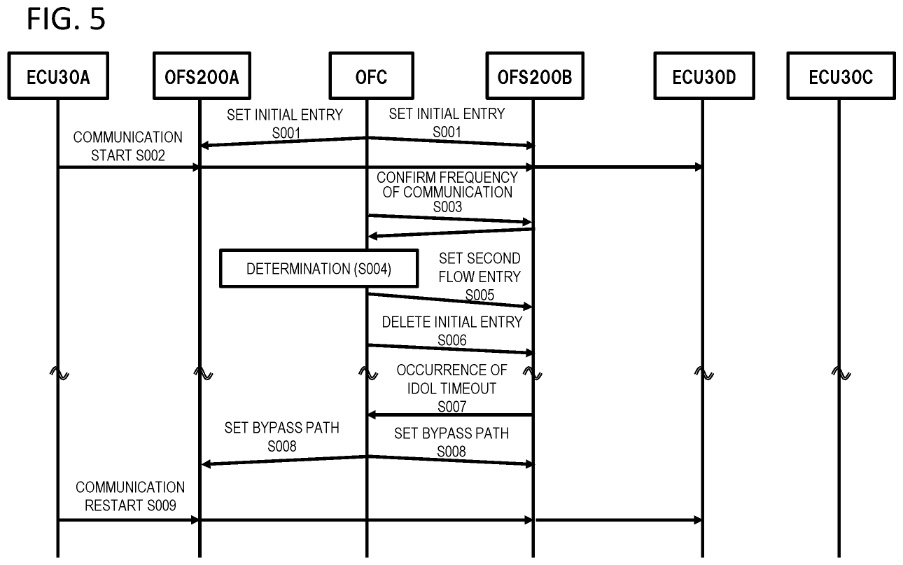

To continue, it will be described about an operation of the present exemplary embodiment by referring to figures in detail. In the following explanation, FIG. 5 is a sequence diagram illustrating an operation of the in-vehicle communication system in the first exemplary embodiment of the present invention. In the following explanation, it will be explained under an assumption that the ECU 30A transmits a packet(s) to the ECU 30D periodically in a steady state. Firstly, as illustrated in FIG. 5, the OFC 100 sets, to the OFSs 200A and 200B as an initial entry, a flow entry(ies) causing to transfer, from the ECU 30A side to the ECU 30D side, a packet whose transmission source is the ECU 30A and destination is the ECU 30D (Step S001).

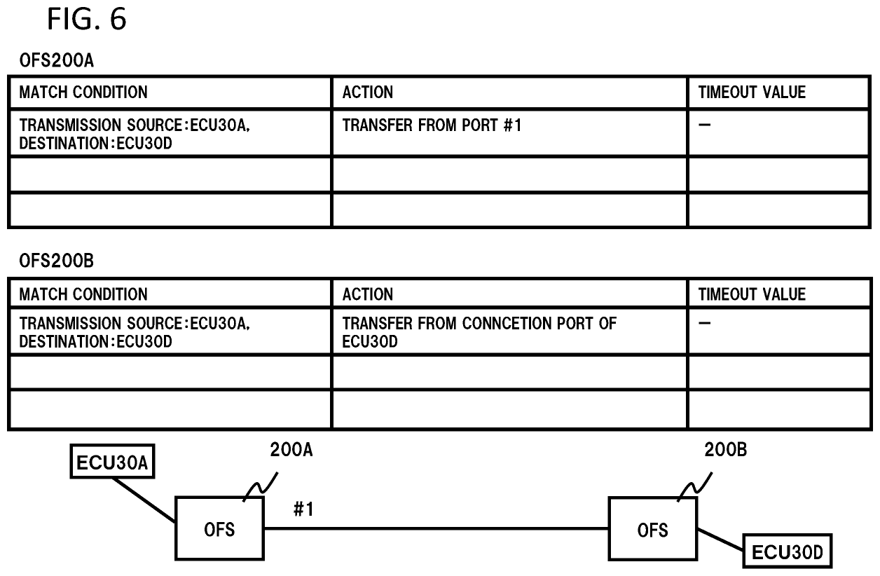

FIG. 6 is a diagram illustrating flow entries set in the OFS 200A and 200B at the time of above Step S001. A flow entry transferring, from a port #1 being a connection port(s) of the OFS 200B, the packet whose transmission source is the ECU 30A and destination is the ECU 30D is set in OFS 200A. A flow entry transferring, to the ECU 30D, the packet whose transmission source is the ECU 30A and destination is the ECU 30D is set in the OFS 200B.

After that, the ECU 30A is activated, and when the ECU 30A transmits the packet(s) destined to the ECU 30D, the packet(s) is transferred by the OFSs 200A and 200B (Step S002). On the other hand, the configuration management part 102 of the OFC 100 monitors a communication state of the OFS 200B periodically (Step S003). For this confirmation, it is possible to use a message (Stats Request/Reply) or the like for confirming statistical information of an OFS from an OFC specified in Non-Patent Literature 1.

Next, the configuration management part 102 of the OFC 100 determines whether or not a frequency of communication destined to the ECU 30D from the ECU 30A acquired by Step S003 exceeds a predetermined threshold value (Step S004). As the predetermined threshold value, a value less than a frequency of transmission of the packet(s) destined to the ECU 30D in the steady state of the ECU 30A and greater than a frequency of transmission of the packet(s) destined to the ECU 30D immediately after the ECU 30A is activated. Here, if the frequency of communication destined to the ECU 30D from the ECU 30A does not exceed the predetermined threshold value, a process of Steps S002 to S004 will be repeated.

On the other hand, in Step S004, if it is determined that the frequency of communication destined to the ECU 30D from the ECU 30A exceeds the predetermined threshold value, the OFC 100 sets a second flow entry for fault detection to the OFS 200B (Step S005). This second control entry for fault detection is a flow entry for detecting a packet(s) transmitted from the ECU 30.

Next, the OFC 100 instructs deletion of the flow entry(ies) set in Step S001 to the OFS 200B (Step S006).

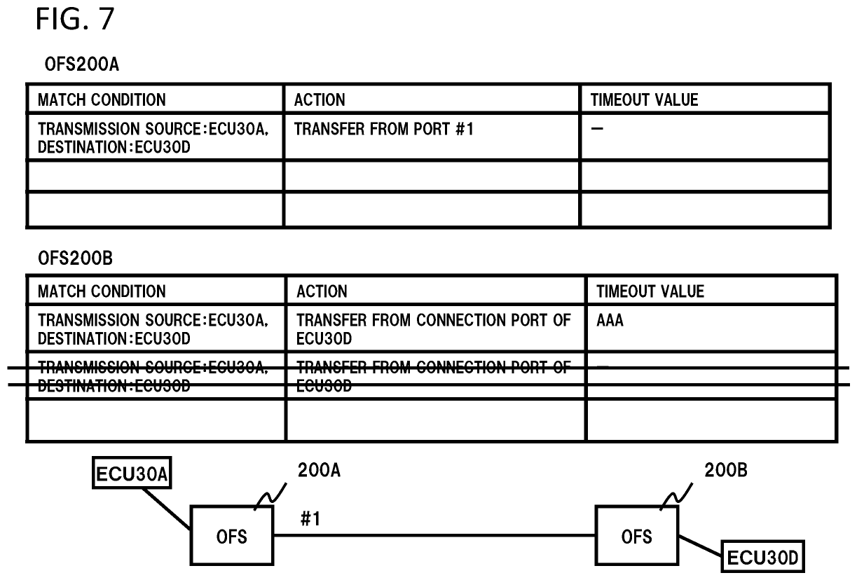

FIG. 7 is a diagram illustrating flow entries set in the OFSs 200A and 200B at the time of above Step S006. Though there is no difference (or change) in the flow entry set in the OFS 200A, the flow entry to which a timeout value is set is set in the OFS 200B. This timeout value is an idle timeout value and the flow entry is deleted if there is no reception of the packet(s) destined to the ECU 30D from the ECU 30A for a period of value “AAA”.

The OFS 200B performs a report to the OFC 100 when the OFS 200B performs deletion of the flow entry(ies) by a timeout (Step S007). The OFC 100 can grasp an occurrence of communication interruption between the OFS 200A and the OFS 200B. Further, as the deletion report of this flow entry(ies), it is possible to use a message (Flow Removed) or the like notifying flow deletion by the OFS specified in Non-Patent Literature 1.

The configuration management part 102 of the OFC 100 which has grasped the communication disconnection between the OFSs 200A and OFS 200B updates contents of the configuration management part 102 and requests, to the OFS control part 101, calculation of a bypass path(s) and setting of an alternative flow entry(ies). In the present exemplary embodiment, since a reserve path(s) connected by ports #2, #2 between the OFS 200A and OFS 200B is provided, the reserve path(s) is calculated as an alternative path(s). Finally, the OFC 100 sets a flow entry(ies) causing to transfer, by the bypass path(s), the packet whose transmission source is the ECU 30A and destination is the ECU 30D (Step S008).

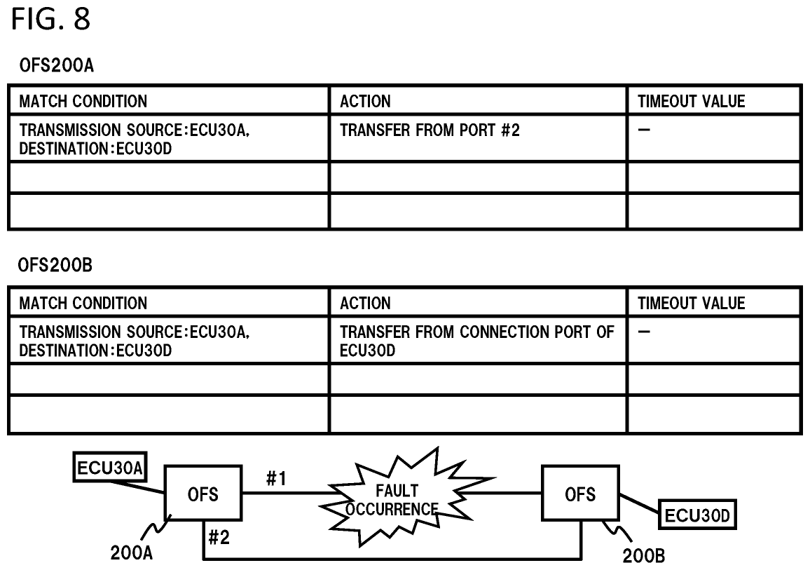

FIG. 8 is a diagram illustrating flow entries set in the OFSs 200A and 200B at the time of above Step S008. The flow entry transferring, from the port #2 being a connection port of the OFS 200B, the packet whose transmission source is the ECU 30A and destination is the ECU 30D is set in the OFS 200A. The flow entry transferring, to the ECU 30D, the packet whose transmission source is ECU 30A and destination is the ECU 30D is set in the OFS 200B.

Hereafter, if the ECU 30A transmits the packet(s) destined to the ECU 30D, the packet(s) is transferred by the OFSs 200A and 200B via the bypass path (Step S009; communication restart).

As explained above, according to the present exemplary embodiment, it is possible to detect an abnormality of a communication path(s) and perform faster recovery operation without performing transmission of the above frame for inspection or the like.

### SECOND EXEMPLARY EMBODIMENT

Next, it will be explained about a second exemplary embodiment possible to omit the determination process of the frequency of communication of the OFC 100 in Step S004 in the above first exemplary embodiment by referring to figures in detail. Hereinafter, since the second to a fourth exemplary embodiments can be realized by the same configuration as the first exemplary embodiment, it will be explained mainly about a different point of this operation.

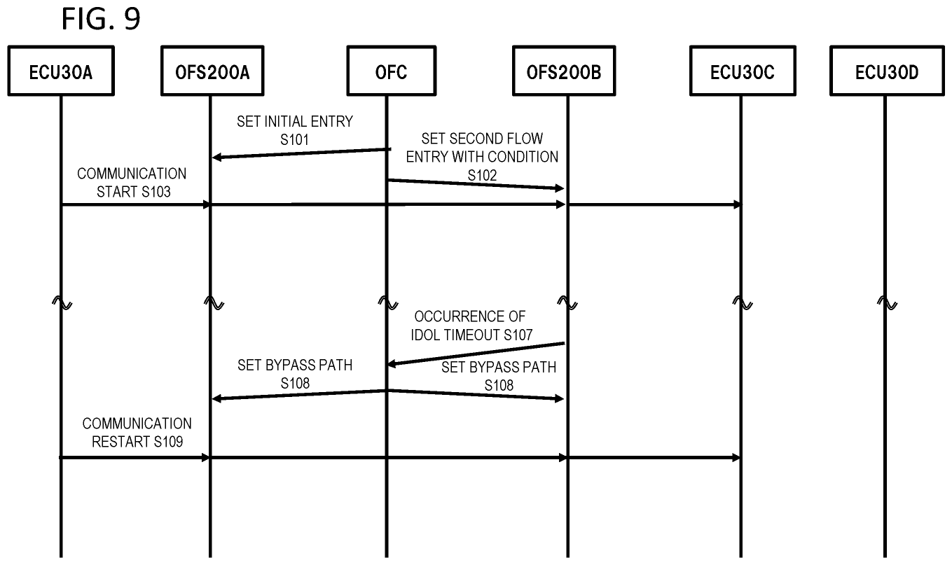

FIG. 9 is a sequence diagram illustrating an operation of an in-vehicle communication system in the second exemplary embodiment of the present invention. In Step S101 in FIG. 9, a flow entry(ies) that an OFC 100 sets to an OFS 200A is the same as the first exemplary embodiment (Step S101).

On the other hand, the OFC 100 sets a flow entry(ies) with an operation start condition to an OFS 200B (Step S102).

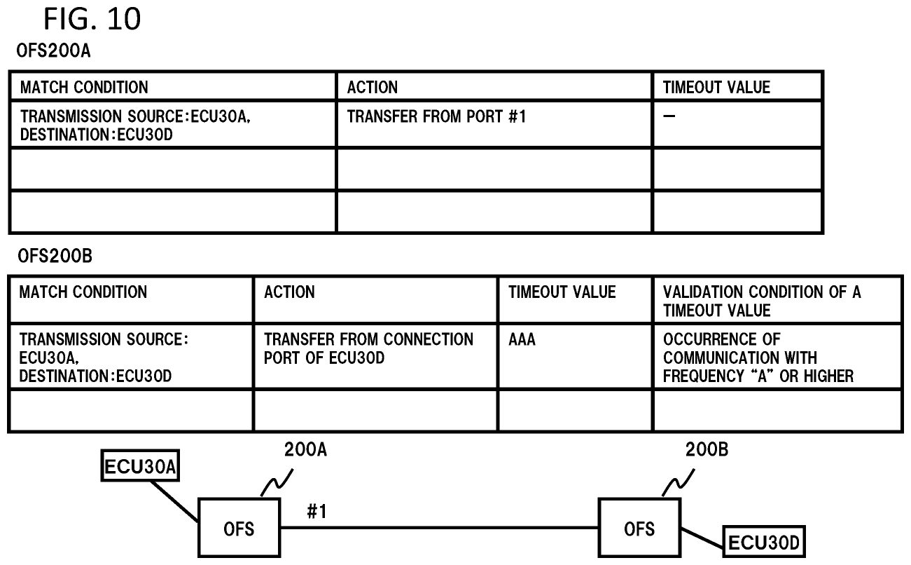

FIG. 10 is a diagram illustrating flow entries set in the OFSs 200A and 200B at the time of above Steps S101 and S102. The flow entry transferring, from a port #1 being a connection port of the OFS 200B, a packet whose transmission source is an ECU 30A and destination is an ECU 30D is set in the OFS 200A. On the other hand, the flow entry (a third flow entry) that a timeout value is validated when reception of the packet whose transmission source is the ECU 30A and destination is the ECU 30D equals to a predetermined frequency or more is set in the OFS 200B.

According to such a combination of the flow entries, after the ECU 30A starts transmission of the packet(s) destined to the ECU 30D in Step S103 of FIG. 9, when a frequency of the transmission equals to a predetermined value (frequency A) or more, a “VALIDATION CONDITION OF A TIMEOUT VALUE” (occurrence of communication with the frequency “A” or higher) in FIG. 10 is established and the timeout value of the flow entry(ies) is validated. Therefore, after that, it becomes a state that an initial entry is set in the OFS 200A and a second flow entry is set in the OFS 200B, the same as FIG. 7. Accordingly, if a communication fault occurs in a link(s) between the OFS 200A and OFS 200B, the second flow entry is deleted by a time out and a deletion report of a flow entry(ies) is performed to the OFC 100 (Step S107). Since subsequent operations are the same as those in first exemplary embodiment, explanation is omitted.

As explained above, according to the present exemplary embodiment, it is possible to detect an abnormality of a communication path(s) and perform faster recovery operation, as same as the first exemplary embodiment, without performing confirmation of a frequency of communication by the OFC 100 side or set and deletion of a subsequent flow entry(ies).

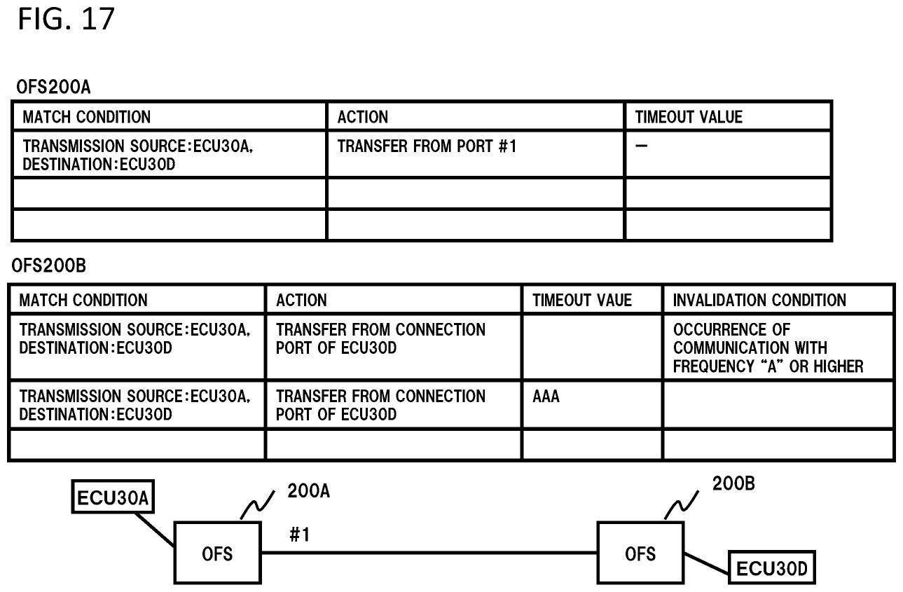

Further, it is possible to use combinations of flow entries illustrated in FIG. 17 instead of the combinations of the flow entries illustrated in FIG. 10. In an example of FIG. 17, the flow entry (a fourth flow entry) which is invalidated when reception of a packet whose transmission source is the ECU 30A and destination is the ECU 30D equals to a predetermined frequency or more and a second flow entry for fault detection are set, instead of the third flow entry with a validation condition of the timeout value. This second flow entry for fault detection is the same as the flow entry set in Step S005 in the first exemplary embodiment. A higher priority degree than the second flow entry is given in the above fourth flow entry. Even if this configuration is also adopted, when reception of a packet(s) equals to a predetermined frequency or more, since the fourth flow entry is invalidated, it becomes the same state as FIG. 7 that the second flow entry is set to the OFS 200B.

### THIRD EXEMPLARY EMBODIMENT

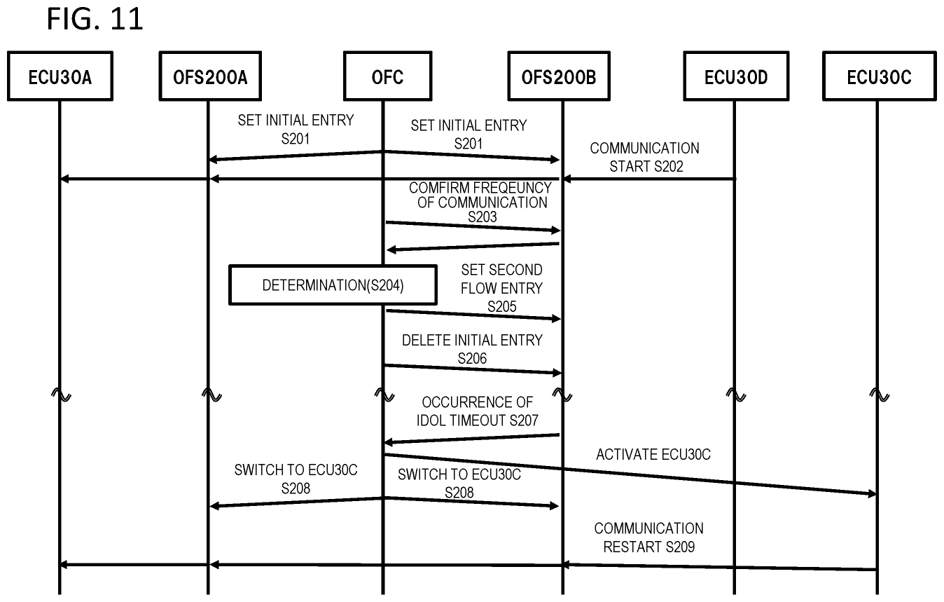

Successively, it will be explained about a third exemplary embodiment performing detection not of a fault of a communication path(s) but of failure of an ECU(s) by referring to figures in detail. FIG. 11 is a sequence diagram illustrating an operation of an in-vehicle communication system in the third exemplary embodiment of the present invention. In the following explanation, it will be explained under an assumption that an ECU 30D transmits a packet(s) to an ECU 30A periodically in a steady state. In addition, it will be explained under an assumption that an ECU 30C is possible to operate as a standby system to the ECU 30D.

Firstly, as illustrating in FIG. 11, an OFC 100 sets, to OFSs 200A and 200B as an initial entry, flow entries causing to transfer, from the ECU 30D side to the EU 30A side, a packet whose transmission source is the ECU 30D and destination is the ECU 30A (Step S201).

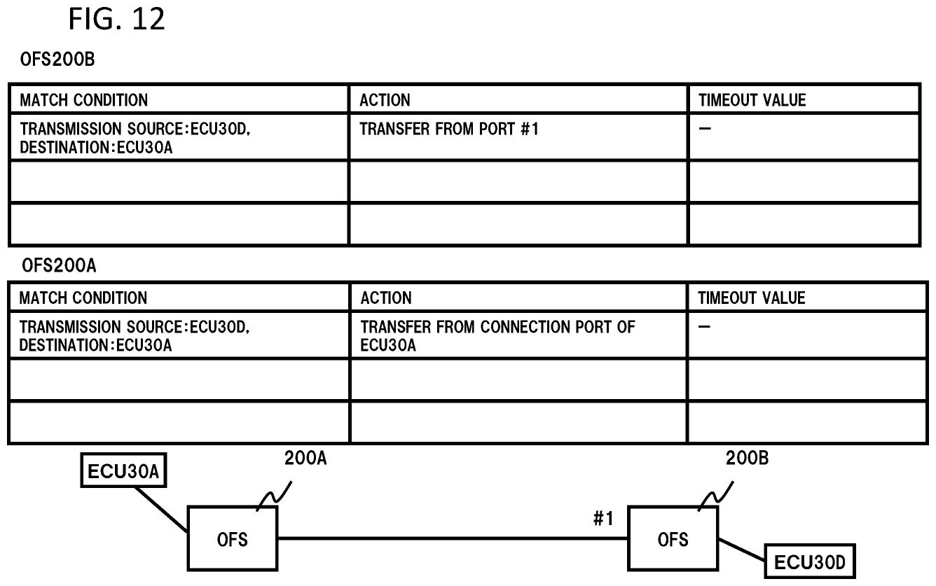

FIG. 12 is a diagram illustrating flow entries set in the OFSs 200A and 200B at the time of the above S201. The flow entry transferring, from a port #1 being a connection port of the OFS 200A, a packet whose transmission source is the ECU 30D and destination is the ECU 30A is set in the OFS 200B. The flow entry transferring, to the ECU 30A, the packet whose transmission source is the ECU 30D and destination is the ECU 30A is set in the OFS 200A.

After that, the ECU 30D is activated, when the ECU 30D transmits the packet(s) destined to the ECU 30A, the packet(s) is transferred by the OFSs 200A and 200B (Step S202). On the other hand, a configuration management part 102 of the OFC 100 monitors a communication state of the OFS 200B periodically (Step S203). For this confirmation, it is possible to use a message (Stats Request/Reply) or the like for confirming statistical information of an OFS from an OFC specified in Non-Patent Literature 1.

Next, the configuration management part 102 of the OFC 100 determines whether or not a frequency of communication destined to the ECU 30A from the ECU 30D acquired by Step S203 exceeds a predetermined threshold value (Step S204). As the predetermined threshold value, a value that is smaller than a frequency of transmission (standard communication interval) of a packet(s) destined to the ECU 30A in a steady state of the ECU 30D and is larger than a frequency of transmission of a packet(s) destined to the ECU 30A immediately after the ECU 30D is activated is set. Here, when the frequency of communication destined to the ECU 30A from the ECU 30D does not exceed the predetermined threshold value, it becomes to repeat Steps S202 to S204.

On the other hand, in Step S204, when the OFC 100 determines that the frequency of communication destined to the ECU 30A from the ECU 30D exceeds the predetermined threshold value, the OFC 100 sets a second flow entry for fault detection to the OFS 200B (Step S205). The second flow entry for fault detection is a flow entry in which, additional to a match condition to detect the packet(s) destined to the ECU 30A from the ECU 30D and an action, a flow entry(ies) to which an idol timeout value is set. Further, this idol timeout value is also decided dependently on a transmission interval of data or type of the data which an ECU(s) of transmission source transmits. For example, as the idol timeout value, it is possible to adopt a value which is n times (however, n is an arbitrary value exceeding “1”. For example, “3” times) value of the frequency of transmission (the frequency of communication) of the packet(s) destined to the ECU 30A from the ECU 30D.

Next, the OFC 100 instructs deletion of the flow entry(ies) set by Step S201 to the OFS 200B (Step S206).

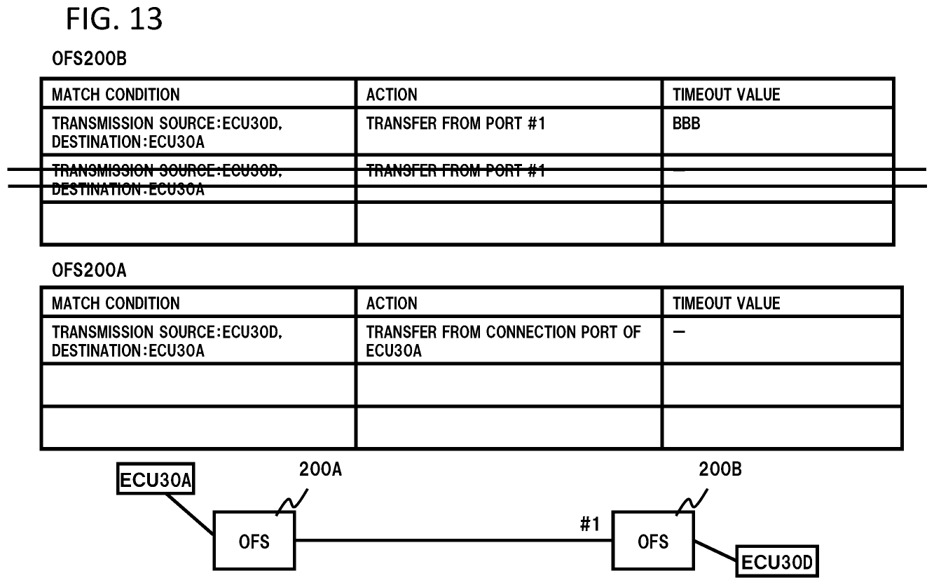

FIG. 13 is diagram illustrating flow entries set in the OFSs 200A and 200B at the time of above Step S206. Though there is no difference in the flow entry set in the OFS 200A, the flow entry to which a timeout value is set is set in the OFS 200B. This timeout value is an idle timeout value and the flow entry is deleted if there is no reception of the packet(s) destined to the ECU 30A from the ECU 30D for a period of value “BBB”.

The OFS 200B performs a report to the OFC 100 when the OFS 200B performs deletion of the flow entry(ies) by a timeout (Step S207). Thereby, the OFC 100 can grasp that a packet(s) input from the ECU 30D to the OFS 200B is interrupted. Further, as a deletion report of this flow entry(ies), it is possible to use a message (Flow Removed) or the like notifying flow deletion by an OFS specified in Non-Patent Literature 1.

The configuration management part 102 of the OFC 100 which grasped communication interruption between the ECU 30D and OFS 200B updates contents of the configuration management part 102. Further, the configuration management part 102 of the OFC 100 requests calculation of a path(s) which starts from an ECU(s) of a standby system with respect to the ECU 30D and set of an alternative flow entry(ies). In the present exemplary embodiment, since the ECU 30C is prepared as the ECU(s) of the standby system of the ECU 30D, the OFS control part 101 calculates a path(s) via the ECU 30C, the OFS 200B, the OFS 200A, and the ECU 30A. Finally, the OFC 100 sets a flow entry(ies) causing to transfer, via the OFS 200B and OFS 200A, a packet whose transmission source is the ECU 30C and destination is the ECU 30A (Step S208).

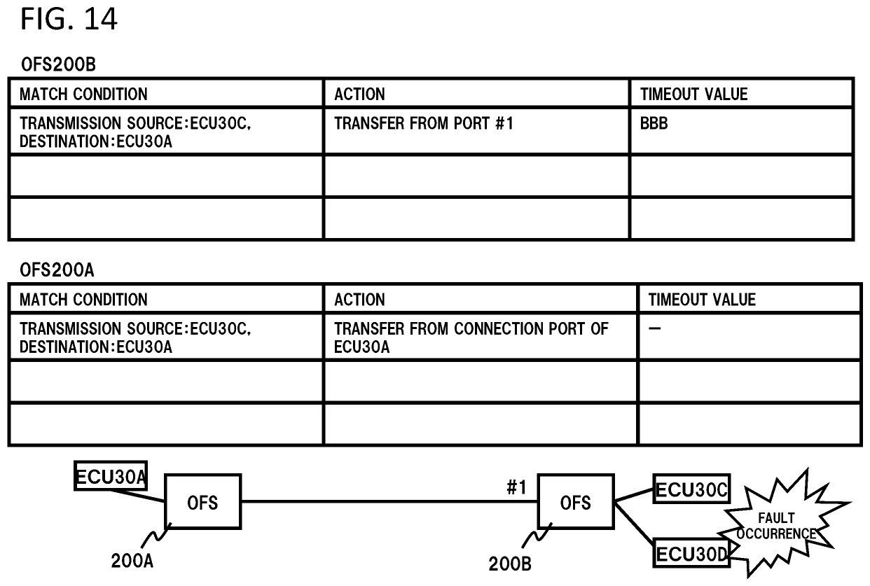

FIG. 14 is a diagram illustrating flow entries set in the OFSs 200A and 200B at the time of above Step S208. The flow entry transferring, from the port #1 to which the OFS 200A is connected, the packet whose transmission source is the ECU 30C and destination is the ECU 30A is set in the OFS 200B. The flow entry transferring, to the ECU 30A, the packet whose transmission source is the ECU 30C and destination is the ECU 30A is set in the OFS 200A.

After that, when the ECU 30C transmits the packet(s) destined to the ECU 30A, the packet(s) is transferred via the OFSs 200A and 200B (Step S209; communication restart).

As explained above, in the present exemplary embodiment, it is possible to detect an abnormality of an ECU(s) and perform faster recovery operation without performing transmission of the above frame for inspection or the like.

### FOURTH EXEMPLARY EMBODIMENT

Successively, it will be explained about a fourth exemplary embodiment possible to omit the determination process of the frequency of communication of the OFS 100 in Step S204 of the above second exemplary embodiments.

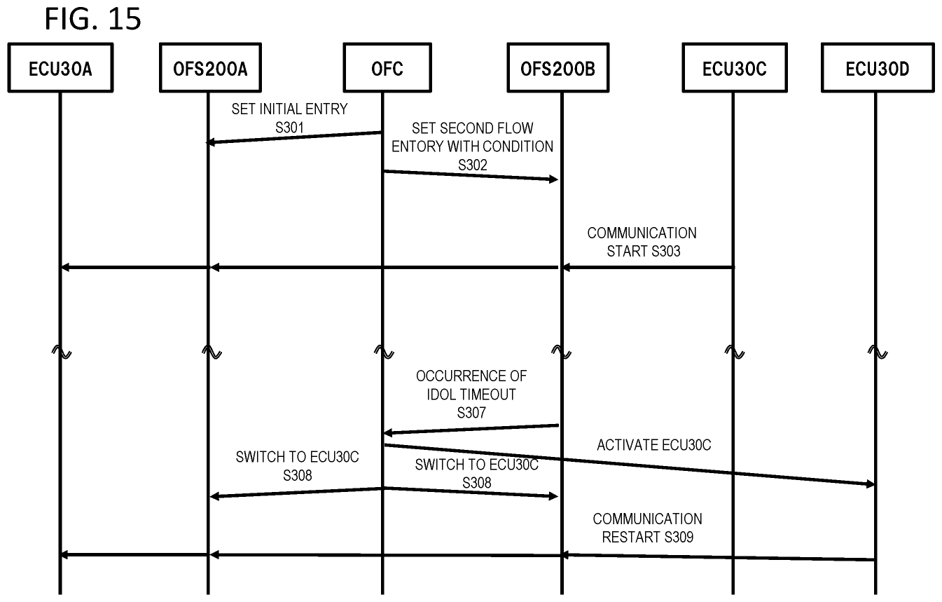

FIG. 15 is a sequence diagram illustrating an operation of an in-vehicle communication system in the fourth exemplary embodiment of the present invention. A flow entry(ies) that an OFC 100 sets to an OFS 200A in Step S301 of FIG. 15 is the same as the third exemplary embodiment (Step S301).

On the other hand, the OFC 100 sets a flow entry(ies) with an operation start condition to an OFS 200B (Step S302).

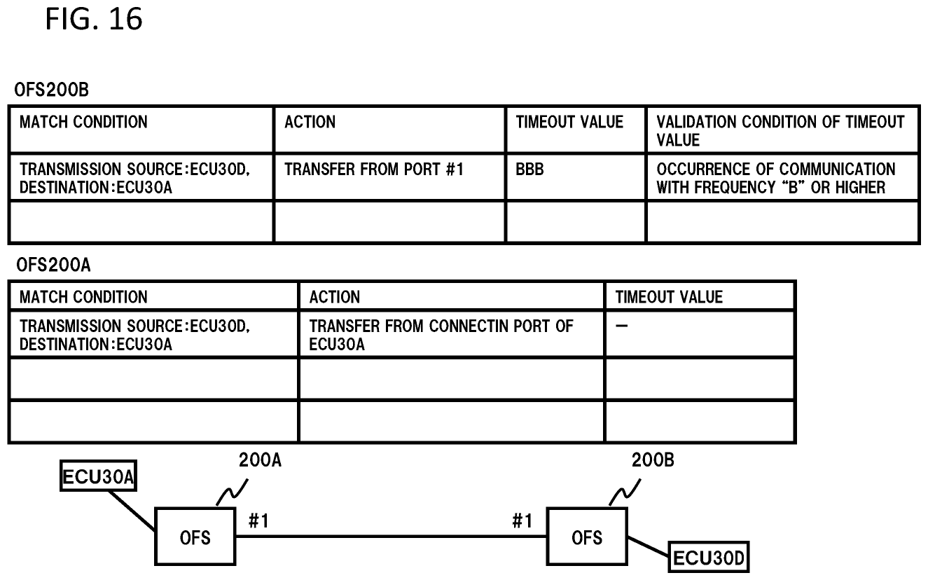

FIG. 16 is a diagram illustrating flow entries set in the OFSs 200A and 200B at the time of above Steps S301 and S302. The flow entry (a third flow entry) by which a timeout value is validated when reception of a packet whose transmission source is an ECU 30D and destination is an ECU 30A equals to a predetermined frequency “B” or more is set in the OFS 200B. On the other hand, the flow entry transferring, to the ECU 30A, the packet whose transmission source is the ECU 30D and destination is the ECU 30A is set in the OFS 200A.

According to combinations of these flow entry(ies), after the ECU 30D starts transmission of the packet(s) destined to the ECU 30A in Step S303 of FIG. 15, when a frequency of its transmission equals to a predetermined value (frequency “B”) or more, the “VALIDATION CONDITION OF A TIMEOUT VALUE” (occurrence of communication with the frequency “A” or higher) in FIG. 10 is established and a timeout value of the flow entry(ies) is validated. Therefore, after that, it becomes to be the same state as FIG. 13 in which an initial entry is set in the OFS 200A and a second flow entry is set in the OFS 200B. Accordingly, if a fault occurs in the ECU 30D, the second flow entry is deleted by a timeout and a deletion report of the flow entry(ies) is performed to the OFC 100 (Step S307). Since subsequent operations are the same as those in third exemplary embodiment, explanation is omitted.

As explained above, in the present exemplary embodiment, it is possible to detect an abnormality of an ECU(s) and perform faster recovery operation, as same as the third exemplary embodiment, without confirming a frequency of communication or setting and deleting a subsequent flow entry(ies) by the OFC 100 side.

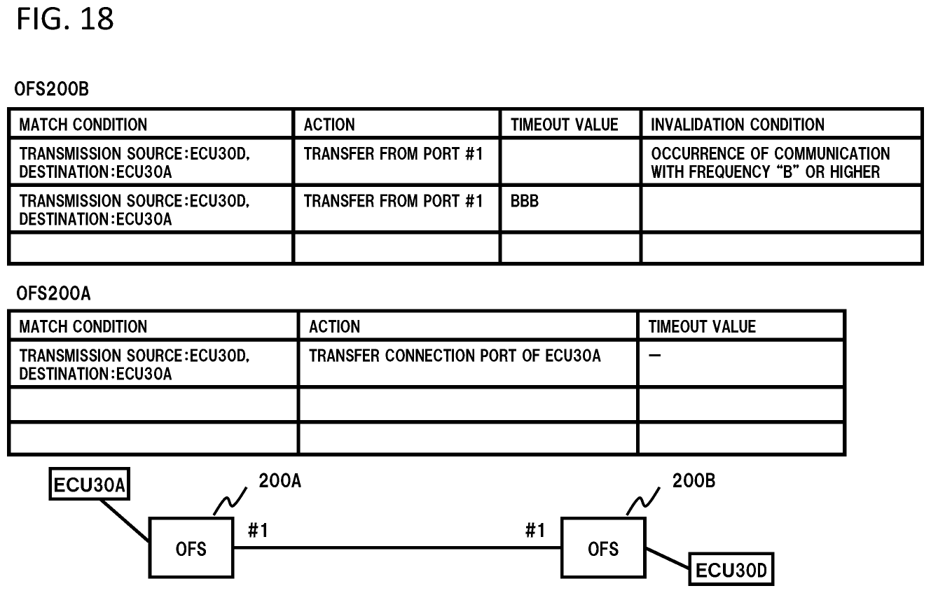

Further, it is possible to use combinations of flow entries illustrating in FIG. 18 instead of combinations of the flow entries illustrating in FIG. 16. In an example of FIG. 18, the flow entry (a fourth flow entry) which is invalidated when reception of a packet whose transmission source is the ECU 30D and destination is the ECU 30A equals to a predetermined frequency or more and a second flow entry for fault detection are set, instead of the third flow entry with a validation condition of a timeout value. This second flow entry for fault detection is the same as the second flow entry set in Step S205 in the above third exemplary embodiment. The above fourth flow entry is given a higher priority degree than the second flow entry. Even if this configuration is also adopted, when reception of a packet(s) equals to a predetermined frequency or more, since the fourth flow entry is invalidated, it becomes the same state as FIG. 13 in which the second flow entry is set in the OFS 200B.

Though each of exemplary embodiments of the present invention is explained, the present invention is not limited to the above exemplary embodiments, and it possible to add further modification, replacement, and adjustment within a range not deviating from technical idea of the present invention. For example, a network configuration, a configuration of each element, and an expression form of a message illustrated in each figure are examples to facilitate the understanding of the present invention, and are not limited to the configurations illustrated in these figures. Further, in the following description, “A and/or B” is used in the sense of at least any one of A and B.

For example, though it is explained as that the switches in the vehicle are controlled by using the OpenFlow in the above exemplary embodiments, it is possible to realize the present invention by using a scheme other than the OpenFlow.

In addition, though it is explained as that the flow entry(ies) specialized for detection of an abnormality of the communication path(s) and of the ECU(s) is set in the above explained exemplary embodiments, it is possible to combine each of the exemplary embodiments in so far as a match condition of these flow entries does not conflict. For example, if the first exemplary embodiment (or the second exemplary embodiment) and third exemplary embodiment (or the fourth exemplary embodiment) are combined, it is obtained a configuration possible to detect both of an abnormality of a communication path(s) between OFSs and failure of an ECU(s). In addition, in the above explained exemplary embodiments, though it is explained as an example that a transmission source of a packet(s) is the ECU 30A and ECU 30D, it is also possible to apply in a case where another ECU(s) transmits in a steady state. For example, in FIG. 3, in a case where the ECU 30B transmits the packet(s) to the ECU 30C, it is possible to detect failure of the communication path(s) or the ECU(s) by setting a flow entry(ies) as same as the first to fourth exemplary embodiments.

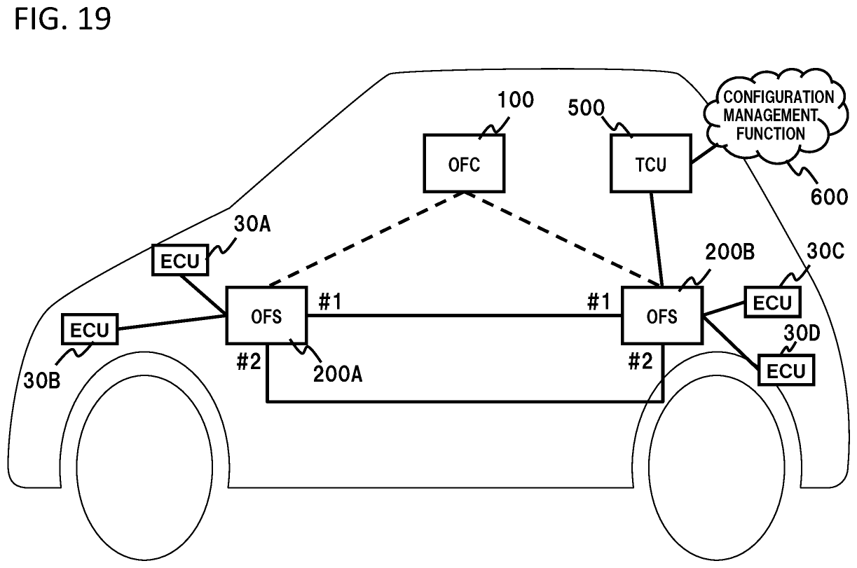

Though, in the above exemplary embodiments, as a function recovery process, it is exemplified about the transfer by the bypass path(s) and the switch(es) to the ECU(s) of the standby system, it is not limited to this concerning the function recovery process. For example, as illustrating in FIG. 19, when a TCU (Tele-Communication Unit) 500 is installed on a vehicle, it is also possible to adopt a scheme of reporting detected contents or the like of an abnormality to a predetermined management apparatus, for example, a configuration management function 600 or the like of a cloud side. In this case, the configuration management function 600 of the cloud side instructs, to the OFC 100 or an arbitrary ECU(s) in the vehicle, securing of an alternative path(s), activation of the ECU(s) of the standby system, rewriting of a program(s) (reprogramming) of an ECU(s) or the like, based on the reported contents of the abnormality.

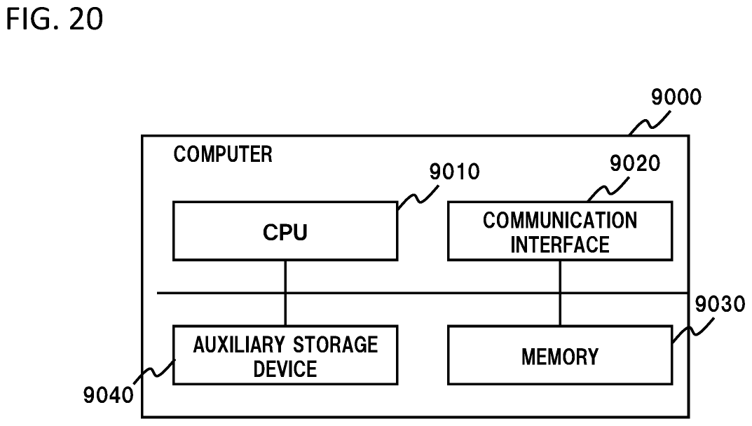

In addition, procedures described in the above first to fourth exemplary embodiments are possible to realize by a program causing a computer (“9000” in FIG. 20) functioning as the control apparatus or the OFC to realize functions as these apparatuses. This computer is exemplified as a configuration including a CPU (Central Processing Unit) 9010, communication interface 9020, memory 9030, auxiliary storage device 9040 of FIG. 20. That is, it is enough to cause the CPU 9010 of FIG. 20 to execute a switch(es) control program or configuration management program and execute an update processing of each calculation parameter held in the auxiliary storage device 9040 or the like.

That is, the each part (processing means, function) of the control apparatus or the OFC described in the above exemplary embodiments can be realized by a computer program causing a processor installed in the control apparatus or the OFC to execute the above each processing by using its hardware.

Finally, preferable Modes of the present invention are summarized.

### [First Mode]

(Refer to the control apparatus according to the first aspect.)

### [Second Mode]

The control part of the above control apparatus may execute a predetermined function recovery process according to a result of the determination.

### [Third Mode]

The above control apparatus can set an idol timeout value of the second control entry based on a standard communication interval of the ECU(s) after a frequency of communication of the ECU(s) exceed a predetermined threshold value.

### [Fourth Mode]

The control apparatus may determine that an ECU(s) is failed and switch over to a path(s) to an alternative ECU(s) of the ECU(s) when it is detected that a packet(s) transmitted from the ECU(s) is interrupted in a switch(es) connected to the ECU(s) performing the communication.

### [Fifth Mode]

The control apparatus may determine that a communication path(s) is abnormal and switch over communication between the ECUs to an alternative path(s) of the communication path(s) determined the abnormality, when it is detected that a packet(s) transmitted from the ECU(s) is interrupted between switches on the communication path(s) between the ECUs.

### [Sixth Mode]

The control apparatus can adopt a configuration setting: a third control entry which is validated under a condition that a frequency of communication between the ECUs exceeds a predetermined threshold value and detects a packet(s)t transmitted from the ECU(s), instead of setting the second control entry for detecting the packet(s) transmitted from the ECU(s), triggered by that the frequency of communication of the ECU(s) exceeds the predetermined threshold value.

### [Seventh Mode]

The control apparatus can adopt a configuration, instead of setting the second control entry for detecting the packet(s) transmitted from the ECU(s), triggered by that the frequency of communication of the ECU(s) exceed the predetermined threshold value, setting:

a fourth control entry which is deleted under a condition that a frequency of communication between the ECUs exceeds a predetermined threshold value, and
a second control entry, having a lower priority degree than the fourth control entry, for detecting a packet(s) transmitted from the ECU(s).

### [Eight Mode]

The control apparatus can perform a fault report to a predetermined management apparatus, when any one of failure of the ECU(s) and an abnormality of a communication path(s) between the ECUs is detected.

### [Ninth Mode]

(Refer to the in-vehicle communication system according to the second aspect.)

### [Tenth Mode]

(Refer to the communication control method according to the third aspect.)

### [Eleventh Mode]

(Refer to the program according to the fourth aspect.)

Further, it is possible that the modes of ninth to eleventh are expanded to the modes of second to eighth in the same way as the first mode.

Further, it is regarded that the above patent literatures and non-patent literature are incorporated by reference in the present application. Within the entire disclosure of the present invention (including claims), and based on the basic technical concept, it is possible to change and adjust the exemplary embodiments or examples. Also, various combinations or selections (including partial removal) of different disclosed elements (including each element of each claim, each element of each exemplary embodiment or example, each element of each figure, or the like) within the entire disclosure of the present invention are possible. That is, in the present invention, it is of course natural to include various variations or modifications that could be made by a person skilled in the art according to the entire disclosure including claims and the technical concept. Especially, even if there is no explicit description with respect to any number or a small range included in a numerical range described in the present application, it should be interpreted as such be concretely described in the present application.

### REFERENCE SIGNS LIST

10A control apparatus
11A control part
20, 20A to 20C switch
30, 30A to 30D ECU
100 OpenFlow controller (OFC)
200, 200A to 200B OpenFlow switch (OFS)
101 OFS control part
102 configuration management part
103 network configuration storage part (NW configuration storage part)
500 TCU
600 configuration management function
9000 computer
9010 CPU
9020 communication interface
9030 memory
9040 auxiliary storage device

What is claimed is:

1. A control apparatus, comprising:
at least one memory configured to store instructions; and
at least one processor configured to execute the instructions to:
controlling communication in a vehicle by setting a control entry(ies) to a plurality of switches relaying, by referring to the control entry(ies), a packet(s) input to and output from an ECU(s) installed on the vehicle, wherein
the controlling communication comprises setting sets a second control entry for detecting the packet(s) transmitted from the ECU(s), triggered by that a frequency of communication of the ECU(s) exceeds a predetermined threshold value, and determining any one of failure of the ECU(s) and a fault of a communication path(s) according to combination of the switch(es) and a port(s) in which interruption of the packet(s) transmitted from the ECU(s) is detected.

2. The control apparatus according to claim 1, wherein
the controlling communication comprises executing executes a predetermined function recovery process according to a result of the determination.

3. The control apparatus according to claim 1, wherein
the controlling communication comprises setting an idol timeout value of the second control entry based on a standard communication interval of the ECU(s) after the frequency of communication of the ECU(s) exceeds the predetermined threshold value.

4. The control apparatus according to claim 1, wherein
the controlling communication comprises determining that the ECU(s) is failed and switches over to a path(s) to an alternative ECU(s) of the ECU(s), when it is detected that the packet(s) transmitted from the ECU(s) is interrupted in a switch(es) connected to the ECU(s) performing the communication.

5. The control apparatus according to claim 1, wherein
the controlling communication comprises determining that a communication path(s) is abnormal and switches over communication between the ECUs to an alternative path(s) of the communication path(s) determined the abnormality, when it is detected that the packet(s) transmitted from the ECU(s) is interrupted between the switches on the communication path(s) between the ECUs.

6. The control apparatus according to claim 1, wherein
the controlling communication comprises setting a third control entry which is validated under a condition that a frequency of communication between the ECUs exceeds the predetermined threshold value and detects the packet(s) transmitted from the ECU(s), instead of setting the second control entry for detecting the packet(s) transmitted from the ECU(s), triggered by that the frequency of communication of the ECU(s) exceeds the predetermined threshold value.

7. The control apparatus according to claim 1, wherein
the controlling communication comprises performing a fault report to a predetermined management apparatus when any one of failure of the ECU(s) and an abnormality of the communication path(s) between the ECUs is detected.

8. An in-vehicle communication system, comprising:
a plurality of switches which relays a packet(s) input to and output from an ECU(s) installed on a vehicle by referring to a control entry(ies); and
the control apparatus according to claim 1.

9. A monitoring method in a control apparatus including a control part that controls communication in a vehicle by setting a control entry(ies) to a plurality of switches relaying, by referring to the control entry(ies), a packet(s) input to and output from an ECU(s) installed on the vehicle, the method comprising: by the control apparatus,
setting a second control entry for detecting the packet(s) transmitted from the ECU(s), triggered by that a frequency of communication of the ECU(s) exceeds a predetermined threshold value; and
determining any one of failure of the ECU(s) and a fault of a communication path(s) according to combination of the switch(es) and a port(s) in which interruption of the packet(s) transmitted from the ECU(s) is detected.

10. A computer readable, non-transitory recording medium storing a program for causing a computer installed in a control apparatus that controls communication in a vehicle by setting a control entry(ies) to a plurality of switches relaying, by referring to the control entry(ies), a packet(s) input to and output from an ECU(s) installed in the vehicle, to execute processes, the processes comprising:
a process of setting a second control entry for detecting the packet(s) transmitted from the ECU(s), triggered by that a frequency of communication of the ECU(s) exceeds a predetermined threshold value; and
a process of determining any one of failure of the ECU(s) and a fault of a communication path(s) according to combination of the switch(es) and a port(s) in which interruption of the packet(s) transmitted from the ECU(s) is detected.

11. The control apparatus according to claim 2, wherein
the controlling communication comprises setting an idol timeout value of the second control entry based on a standard communication interval of the ECU(s) after the frequency of communication of the ECU(s) exceeds the predetermined threshold value.

12. The control apparatus according to claim 2, wherein
the controlling communication comprises determining that the ECU(s) is failed and switches over to a path(s) to an alternative ECU(s) of the ECU(s), when it is detected that the packet(s) transmitted from the ECU(s) is interrupted in a switch(es) connected to the ECU(s) performing the communication.

13. The control apparatus according to claim 2, wherein
the controlling communication comprises determining that a communication path(s) is abnormal and switches over communication between the ECUs to an alternative path(s) of the communication path(s) determined the abnormality, when it is detected that the packet(s) transmitted from the ECU(s) is interrupted between the switches on the communication path(s) between the ECUs.

14. The control apparatus according to claim 2, wherein
the controlling communication comprises setting a third control entry which is validated under a condition that a frequency of communication between the ECUs exceeds the predetermined threshold value and detects the packet(s) transmitted from the ECU(s), instead of setting the second control entry for detecting the packet(s) transmitted from the ECU(s), triggered by that the frequency of communication of the ECU(s) exceeds the predetermined threshold value.

15. The control apparatus according to claim 2, wherein
the controlling communication comprises performing a fault report to a predetermined management apparatus when any one of failure of the ECU(s) and an abnormality of the communication path(s) between the ECUs is detected.

16. The monitoring method according to claim 9, wherein
the controlling communication comprises executing a predetermined function recovery process according to a result of the determination.

17. The monitoring method according to claim 9, wherein
the controlling communication comprises setting an idol timeout value of the second control entry based on a standard communication interval of the ECU(s) after the frequency of communication of the ECU(s) exceeds the predetermined threshold value.

18. The monitoring method according to claim 9, wherein
the controlling communication comprises determining that the ECU(s) is failed and switches over to a path(s) to an alternative ECU(s) of the ECU(s), when it is detected that the packet(s) transmitted from the ECU(s) is interrupted in a switch(es) connected to the ECU(s) performing the communication.

19. The monitoring method according to claim 9, wherein
the controlling communication comprises determining that a communication path(s) is abnormal and switches over communication between the ECUs to an alternative path(s) of the communication path(s) determined the abnormality, when it is detected that the packet(s) transmitted from the ECU(s) is interrupted between the switches on the communication path(s) between the ECUs.

20. The monitoring method according to claim 9, wherein
the controlling communication comprises setting a third control entry which is validated under a condition that a frequency of communication between the ECUs exceeds the predetermined threshold value and detects the packet(s) transmitted from the ECU(s), instead of setting the second control entry for detecting the packet(s) transmitted from the ECU(s), triggered by that the frequency of communication of the ECU(s) exceeds the predetermined threshold value.
